(19) United States
(12) Patent Application Publication
(10) Pub. No.: US 2011/0035678 A1
(43) Pub. Date: Feb. 10, 2011

(54) METHODS, SYSTEMS, AND COMPUTER PROGRAM PRODUCTS FOR CREATING SHARED MEDIA PAGES TO DOCUMENT LIFE EVENTS

(76) Inventors: Geoff Hamrick, Raleigh, NC (US); George Junginger, Apex, NC (US)

Correspondence Address: MYERS BIGEL SIBLEY & SAJOVEC, PO BOX 37428, RALEIGH, NC, 27627, US

(21) Appl. No.: 12/794,377

(22) Filed: Jun. 4, 2010

Related U.S. Application Data
(60) Provisional application No. 61/184,231, filed on Jun. 4, 2009.

(51) Int. Cl. G06F 3/01

(52) U.S. Cl. 715/751

(57) ABSTRACT

A method of creating shared media pages includes defining a story topic, associating a plurality of users with the story topic, receiving media items related to the story topic from at least one of the plurality of users, and generating a plurality of pages, each of the plurality of users having at least one of the plurality of pages associated therewith, each of the plurality of pages comprising at least one of the media items selected by the associated one of the plurality of users.

### RELATED APPLICATION

This application claims the benefit of and priority to U.S. Provisional Patent Application No. 61/184,231, filed Jun. 4, 2009, the disclosure of which is hereby incorporated herein by reference as if set forth in its entirety.

### FIELD OF THE INVENTION

The present invention relates to the management of electronic media in a collaborative environment, and, more particularly, to methods, systems, and computer program products for creating shared media pages in a collaborative environment.

### BACKGROUND

A photographer has several options for managing photographs: store the images on a computer and organize them using various software programs available for managing photos; create electronic albums, record the photos on a compact disc or other recordable medium, make a digital or physical scrapbook, and/or use an online site to make a photo book. With a photo book, a real book with its own images and text can be created. The resulting book can be printed on digital color printers and bound. Professional printing and binding services often offer free software for easy creation of photo books with professional layouts and individual layout capabilities.

A conventional photo book is typically a passive book designed by one person, regardless of how many people participated in the event, sport, party, etc. A collaborative photo book is one where many people contribute pictures. Even though multiple people may contribute pictures, a photo book site will typically facilitate the creation of a single book that is produced by a single person that is distributed to all collaborators that request a copy.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the disclosure.

According to some embodiments of the present invention, a method of creating shared media pages comprises defining a story topic, associating a plurality of users with the story topic, receiving media items related to the story topic from at least one of the plurality of users, and generating a plurality of pages, each of the plurality of users having at least one of the plurality of pages associated therewith, each of the plurality of pages comprising at least one of the media items selected by the associated one of the plurality of users.

In other embodiments, the method further comprises generating a plurality of books associated with the plurality of users, respectively, each of the plurality of books comprising at least one of the plurality of pages selected by the associated one of the plurality of users.

In still other embodiments, associating the plurality of users with the story topic comprises sending an invitation to the at least one of the plurality of users to collaborate in generating media related to the story topic and receiving an acceptance from the at least one of the plurality of users responsive to the invitation.

In still other embodiments, the method further comprises tagging at least one of the media items with a categorization indicium.

In still other embodiments, the categorization indicium comprises a name of one of the plurality of users, an event, a location, and/or a date.

In still other embodiments, generating the plurality of pages comprises sorting the media items based on a sort criterion, wherein each of the plurality of pages comprises at least one of the sorted media items selected by the associated one of the plurality of users.

In still other embodiments, generating the plurality of pages comprises annotating respective ones of the plurality of pages with text information received from respective ones of the plurality of users associated therewith.

In still other embodiments, the media items comprise photographs, text, video, graphics, clip art, and/or audio.

In further embodiments of the present invention, a system for creating shared media pages comprises a processor configured to define a story topic, associate a plurality of users with the story topic, receive media items related to the story topic from at least one of the plurality of users; and generate a plurality of pages, each of the plurality of users having at least one of the plurality of pages associated therewith, each of the plurality of pages comprising at least one of the media items selected by the associated one of the plurality of users.

In still further embodiments, the processor is further configured to generate a plurality of books associated with the plurality of users, respectively, each of the plurality of books comprising at least one of the plurality of pages selected by the associated one of the plurality of users.

In still further embodiments, the processor is further configured to send an invitation to the at least one of the plurality of users to collaborate in generating media related to the story topic and receive an acceptance from the at least one of the plurality of users responsive to the invitation.

In still further embodiments, the processor is further configured to tag at least one of the media items with a categorization indicium.

In still further embodiments, the categorization indicium comprises a name of one of the plurality of users, an event, a location, and/or a date.

In still further embodiments, the processor is further configured to sort the media items based on a sort criterion, wherein each of the plurality of pages comprises at least one of the sorted media items selected by the associated one of the plurality of users.

In still further embodiments, the processor is further configured to annotate respective ones of the plurality of pages with text information received from respective ones of the plurality of users associated therewith.

In still further embodiments, the media items comprise photographs, text, video, graphics, clip art, and/or audio.

In other embodiments of the present invention, a computer program product for creating shared media pages comprises a computer readable storage medium having computer readable program code embodied therein. The computer readable program code comprises computer readable program code configured to define a story topic, computer readable program code configured to associate a plurality of users with the story topic, computer readable program code configured to receive media items related to the story topic from at least one of the plurality of users, and computer readable program code configured to generate a plurality of pages, each of the plurality of users having at least one of the plurality of pages associated therewith, each of the plurality of pages comprising at least one of the media items selected by the associated one of the plurality of users.

In still other embodiments, the computer program product further comprises computer readable program code configured to generate a plurality of books associated with the plurality of users, respectively, each of the plurality of books comprising at least one of the plurality of pages selected by the associated one of the plurality of users.

In still other embodiments, the computer readable program code configured to associate the plurality of users with the story topic comprises computer readable program code configured to send an invitation to the at least one of the plurality of users to collaborate in generating media related to the story topic and computer readable program code configured to receive an acceptance from the at least one of the plurality of users responsive to the invitation.

In still other embodiments, the computer program product further comprises computer readable program code configured to tag at least one of the media items with a categorization indicium.

Other methods, systems, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a communication network for creating shared media pages in accordance with some embodiments of the present invention;

FIG. 2 illustrates a software architecture that may be used in data processing systems for creating shared media pages in accordance with some embodiments of the present invention;

FIG. 3 is a flowchart that illustrates operations creating shared media pages in accordance with some embodiments of the present invention;

FIGS. 4A-4E are screen shots of a user interface for creating shared media pages in accordance with some embodiments of the present invention;

FIG. 5 is a screen shot that illustrates the ability to upload pictures for creating shared media pages in accordance with some embodiments of the present invention;

FIG. 6 is a screen shot that illustrates the ability to tag media items for creating shared media pages in accordance with some embodiments of the present invention;

FIG. 7 illustrates layout options for shared media pages in accordance with some embodiments of the present invention;

FIG. 8 is a screen shot that illustrates options for selecting a background for shared media pages in accordance with some embodiments of the present invention;

FIG. 9 is a screen shot that illustrates the ability to assemble shared media pages to create a media book in accordance with some embodiments of the present invention; and

FIG. 10 illustrates a profile page for a user participating in creating shared media pages in accordance with some embodiments of the present invention

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The present invention may be embodied as methods, systems, and/or computer program products. Accordingly, the present invention may be embodied in hardware and/or in software (including firmware, resident software, micro-code, etc.). Furthermore, the present invention may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described herein with respect to creating shared media pages comprising photographs with and without accompanying text. It will be understood that the present invention is not limited to a particular type of media, such as photographs, but may include, but is not limited to, photographs, text, video, graphics, clip art, and/or audio.

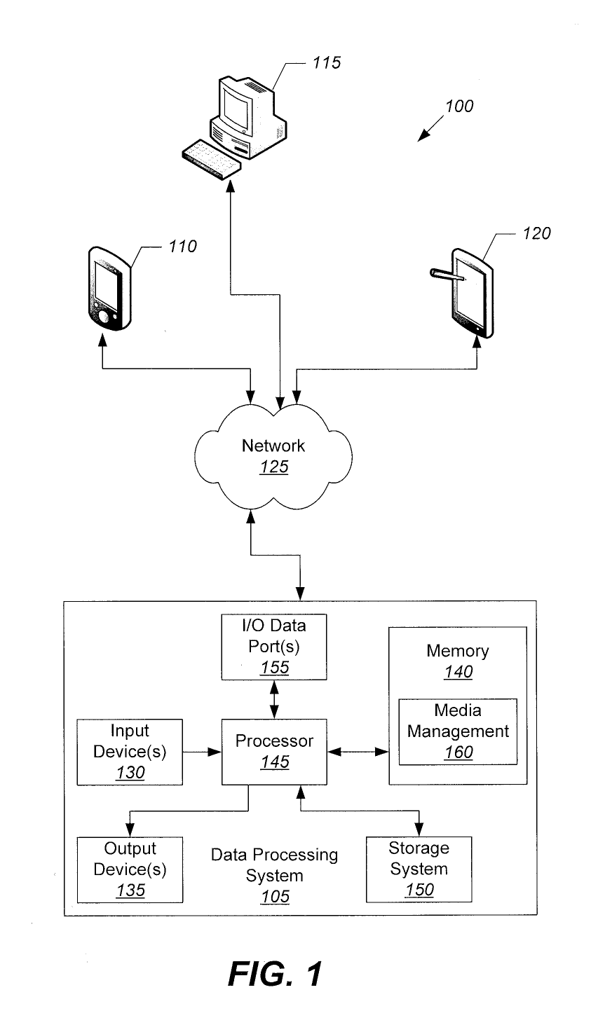

FIG. 1 is a block diagram that illustrates a communication network 100 for creating shared media pages in accordance with some embodiments of the present invention. As shown in FIG. 1, the communication network 100 comprises a data processing system 105 that may be configured to create shared media pages associated with a plurality of users. The users may also generate media books based on the media pages that they create and other users of the system create. The various users of the data processing system 105 are represented by the electronic devices 110, 115, 120. These devices may be any type of electronic device capable of establishing a communication connection with the data processing system 105. The communication connection may be a wireless and/or wireline connection over a communication network, such as network 125 or may be a direct, non-networked connection. In accordance with various embodiments, the network 125 may comprise, for example, the Internet, a wide area network, a local area network, and/or combinations of such networks.

The data processing system 105, in accordance with some embodiments of the present invention, comprises input device(s) 130, output devices 135, such as a display, and a memory 140 that communicate with a processor 145. The input devices 130 and the output devices 135 may comprise various peripheral devices, which include, but are not limited to, an identification card device, an electronic pen that may facilitate electronic signatures for documents, a display or screen, a scanner, a cash/credit acceptor, a keyboard, a mouse, a printer, a camera or other communication device that facilitates two-way live communication, and an audio speaker. The data processing system 105 may further comprise a storage system 150 and an I/O data port(s) 155 that also communicate with the processor 145. The storage system 150 may include removable and/or fixed media, such as floppy disks, ZIP drives, hard disks, or the like as well as virtual storage such as a RAMDISK. The I/O data port(s) 155 may be used to transfer information between the data processing system 105 and another computer system or a network (e.g., an Intranet and/or the Internet). These components may be conventional components, such as those used in many conventional computing devices, and their functionality, with respect to conventional operations, is generally known to those skilled in the art. In accordance with various embodiments of the present invention, the memory 140 may comprise a media management module 160 that may be configured to facilitate the ability of users to create media pages. Each user may also have the option creating a book based on pages that the individual user created and/or based on pages that other users created.

It will be appreciated that the data processing system 105 may be implemented as a single server, separate servers, or a network of servers either co-located in a server farm, for example, or located in different geographic regions.

Some embodiments of the present invention arise based on the observation that individuals live social, communal lives. Most events, sports, and experiences in which individuals participate involve a number of people. Embodiments of the present invention may give users the ability to collaborate on books, share photos, and create their own content to make it unique. This may be referred to as custom community collaboration. All media, such as photos, are uploaded to a communal area. Then, in some embodiments, each person takes those pictures they want to use, adds text, and creates individual story pages about what they remember about the story, season, event, or to make it meaningful to them. From the collected experience of the group members, every user gets to select those pages that are important to them, making each person's book their own—even though they shared the same experience. Embodiments of the present invention may be used by groups of users from all walks of life to document their collective experience the way they remember it. Whether it is a soccer season, a year in high school, or a group of women training to run in “Race for the Cure,” embodiments of the present invention may be used to preserve that memory and experience.

Embodiments of the present invention may allow a person or group to look back and vividly recall events they may not have been able to remember without both the pictures and/or text within the book. Unlike a conventional photo book—which is collaborative, but not customized to the individual's experience and memory, embodiments of the present invention may tell a story of an event(s) the way the user remembers it. In the example of a child participating in a sport, or an event (school play, camping trip, etc.), embodiments of the present invention may allow the child to share their year with others. For example, a child may create a media book about his soccer season and his grandparents live 1500 miles away. They may have seen their grandchild play once, but its more likely that they only get to visit once a year or every couple of years. Now, when the grandparents come for their visit, instead of watching TV or going to the aquarium with their grandchild, they sit down with the media book created using embodiments of the present invention. Page by page, they can see and read about the people their grandchild played with. This prompts them to ask “does your friend Sam go to your school? What other sports does he play? Any brothers or sisters?” It may enable that grandparent to relive that child's experience with them, to be a part of their life, and to remain emotionally connected to them. It may allow a much deeper experience than them just visiting for a few days while they take them to the aquarium and the park. They may still do those things and make those memories. But more importantly, they may become connected to memories, which they weren't there for. Any person who wants to stay emotionally connected to the person may benefit from a media book created in accordance with embodiments of the present invention.

Although FIG. 1 illustrates an exemplary communication network for creating shared media pages in accordance with some embodiments of the present invention, it will be understood that the present invention is not limited to such a configuration but is intended to encompass any configuration capable of carrying out operations described herein.

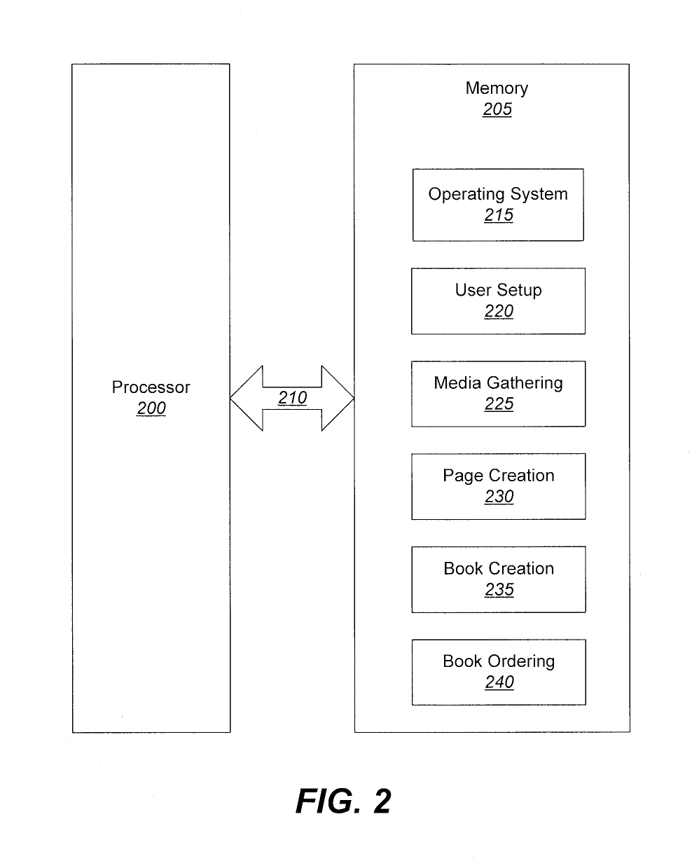

FIG. 2 illustrates a processor 200 and memory 205 that may be used in embodiments of data processing systems, such as the data processing system 105 of FIG. 1, for creating shared media pages in accordance with some embodiments of the present invention. The processor 200 communicates with the memory 205 via an address/data bus 210. The processor 200 may be, for example, a commercially available or custom microprocessor. The memory 205 is representative of the one or more memory devices containing the software and data used to facilitate the creation of shared media pages in accordance with some embodiments of the present invention. The memory 205 may include, but is not limited to, the following types of devices: cache, ROM, PROM, EPROM, EEPROM, flash, SRAM, and DRAM.

As shown in FIG. 2, the memory 205 may contain up to six or more categories of software and/or data: an operating system 215, a user setup module 220, a media gathering module 225, a page creation module 230, a book creation module 235, and a book ordering module 240. The operating system 215 generally controls the operation of the data processing system. In particular, the operating system 215 may manage the data processing system's software and/or hardware resources and may coordinate execution of programs by the processor 200.

The user setup module 220 may be configured to establish user accounts on the data processing system 105. The user setup module 220 may authorize and authenticate new users including an administrator, i.e., a user who wishes to create a collaboration for a new story topic, event, etc., and friends, teammates, contributors, etc., i.e., other users who may wish to collaborate in making and sharing media pages regarding the newly created topic.

The media gathering module 225 may be configured to facilitate the uploading of media onto the data processing system 105 by the various users. This media may include, but is not limited to, photographs, text, video, graphics, clip art, and/or audio.

The page creation module 230 may be configured to facilitate the creation of media pages by the various users. According to some embodiments of the present invention, a user may pick and choose from among media that he/she has uploaded for a particular story topic along with media other users have uploaded for the story topic.

The book creation module 235 may be configured to facilitate the creation of media books by the various users. According to some embodiments of the present invention, a user may pick and choose from among the pages that he/she has created for a particular story topic along with pages other users have created for the story topic to create a customized media book.

The book ordering module 240 may be configured to allow users to order hard copies of the media books that they have created.

Although FIG. 2 illustrates an exemplary software architecture that may be used in data processing systems, such as data processing system 105 of FIG. 1, for creating shared media pages in accordance with some embodiments of the present invention, it will be understood that the present invention is not limited to such a configuration but is intended to encompass any configuration capable of carrying out operations described herein.

Computer program code for carrying out operations of data processing systems discussed above with respect to FIG. 2 may be written in a high-level programming language, such as C or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described herein with reference to flowchart and/or block diagram illustrations of methods, systems, and computer program products in accordance with exemplary embodiments of the invention. These flowchart and/or block diagrams further illustrate exemplary operations for processing and/or filing a tax return, in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

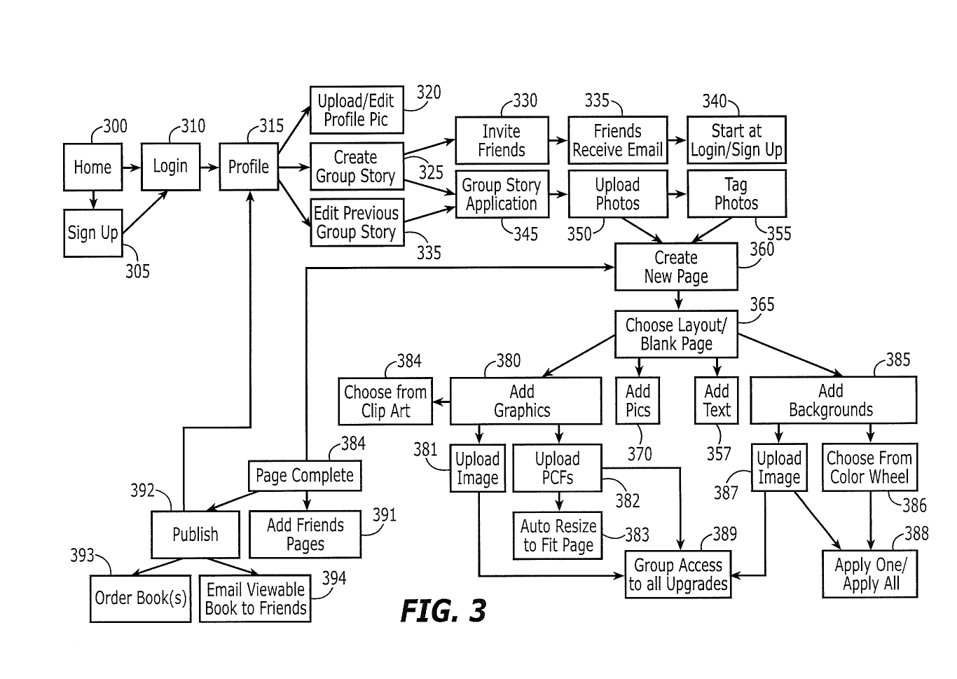

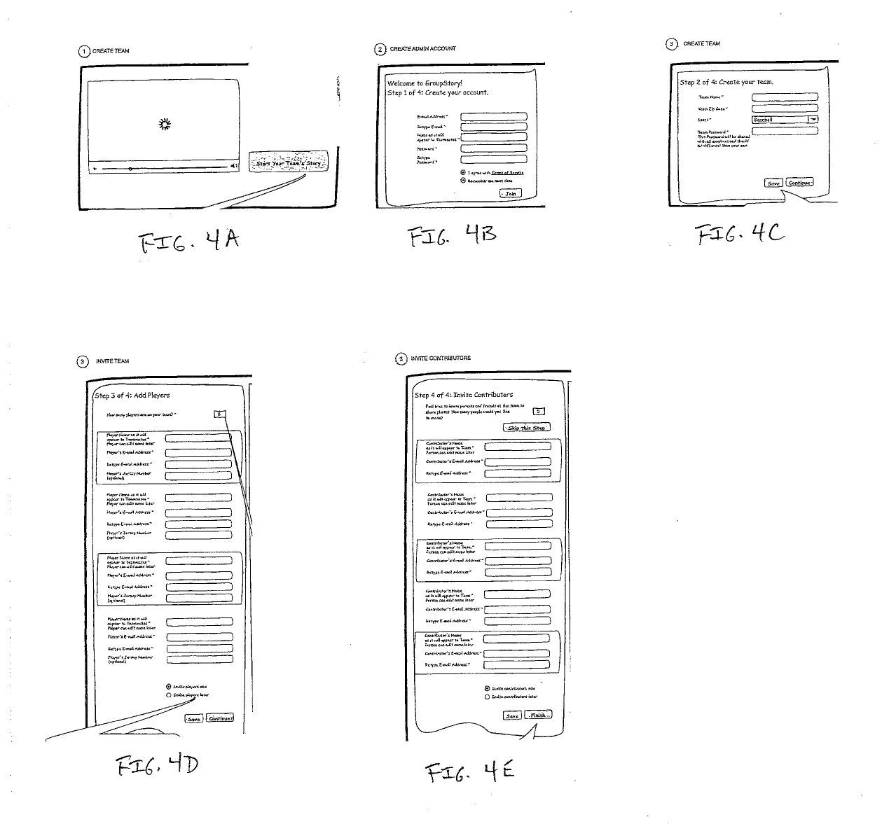

Referring now to FIGS. 3 and 4, exemplary operations for creating shared media pages, in accordance with some embodiments of the present invention, will now be described. Operations begin at block 300 where a new user may browse to a site on the Internet to create begin the process of creating media pages and/or a media book for a particular story, event, etc. as illustrated in FIG. 4A. At block 305, the user signs up with the site as shown in FIG. 4B and logs into the site at block 310. The user creates a profile at block 315, which may include the user's name, contact information, and/or other identifying information. The user may upload a picture for his/her profile at block 320.

At block 325 a user may create a new story topic as shown in FIG. 4C to be documented in collaborative fashion by sharing media and media pages among a plurality of users.

The user that created the new story topic may be considered the administrator for the new topic and may then invite friends, teammates, contributors, etc, as collaborators in providing media and commentary to document the story at block 330. FIGS. 4D and 4E illustrate an example in which the story topic relates to a team event with players on the team being invited (FIG. 4D) and other contributors who are not players on the team, but nevertheless may contribute media in documenting the activities of the team or otherwise have an interest in the team also being invited (FIG. 4E).

Friends and contributors may receive the invitation to collaborate in documenting the new story topic at block 335 and begin the sign up and login procedure described above for the admin user at block 340.

Each of the various users that have signed up may login to the server and start the application for uploading media, creating pages based on the uploaded media that the user and others users have uploaded, and assembling a book that includes pages that the user has created as well as other users have created for the particular story. Because multiple people collaborate and provide media pages documenting various viewpoints of a story or event, a user may create a customized book that incorporates his/her own pages reflecting the user's personal experience as well as the pages of other users that reflect their experiences and viewpoints. Thus, the application may be called a “Group Story” application because users may be able to assemble a book that tells a story from a group point of view.

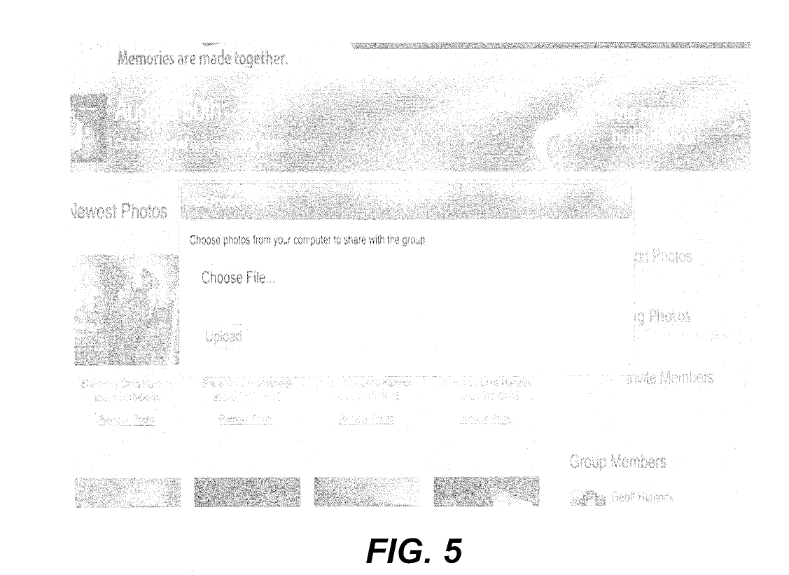

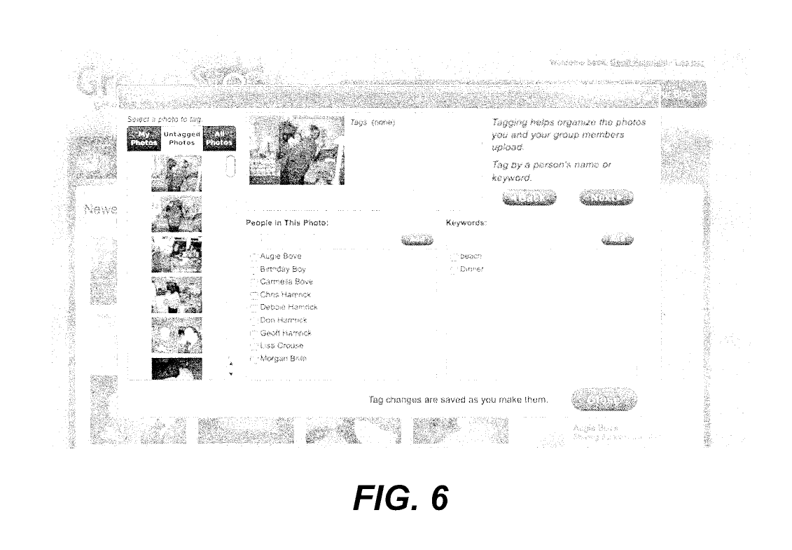

Each user that has been invited to collaborate on a particular story may start the application at block 345. Photos and/or other media can be uploaded at block 350. As shown in FIG. 5, a user can upload photos and/or other media from a variety of sources. At block 355, users may tag photos/media that they or other users have uploaded with one or more indicia to organize the media so that they are easier to search for and retrieve. This is illustrated, for example, in FIG. 6. The indicia may include, but are not limited to, a name of one of the users, an event, a location and/or a date. Using the tags associated with the various media items, a user can sort the items according to various criteria based on the tag. For example, media items could be sorted by user name first and then by date.

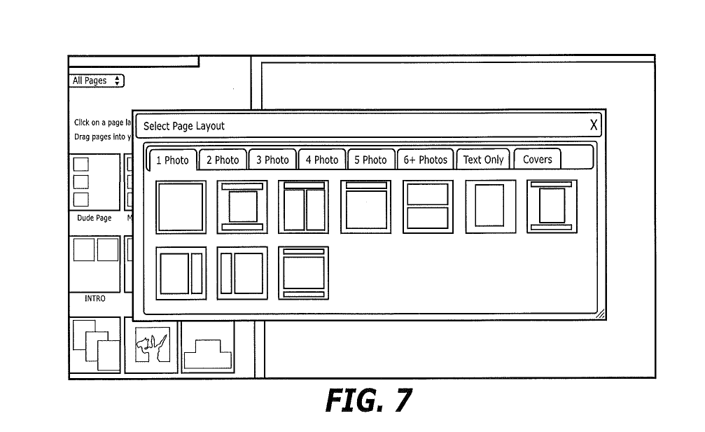

At block 360 a user may create a new media page. As shown in FIG. 7, a user may choose from a variety layout patterns to create their media pages. The layout options may provide the user with a variety of balanced and unique choices to tell their story. According to some embodiments of the present invention, layouts may include options from one to six photos per page with the ability to increase and reduce text space according to user preferences. A collage option may also be provided if a user wishes to include more than six pictures per page.

A user may add media items, such as pictures, to a page at block 370 in a variety of different manners. In some embodiments, pictures and other media items can be drug into a window for the page that the user is constructing. The user may add text as desired at block 375 to annotate the media or provide details of the story associated with the media.

Each page created by a user can be customized in a variety of manners. For example, at block 380 a user may add graphics to a page at block 380. The image (block 381) and/or the PDF (block 382) may be uploaded and resized to fit the page at block at block 383. The option to upload PDFs may be particularly useful for newspaper articles, rosters, and other publications. The graphics may, for example, be related to the particular story or event. If the story is about a baseball season the system may provide standard baseball graphics or users can upload their own baseball graphics. If the story is associated with a Boy Scout troop, then the graphics may be associated with the Boy Scouts. A user may also choose from clip art at block 384, such as quote bubbles, thought bubbles, arrows, stars, and the like.

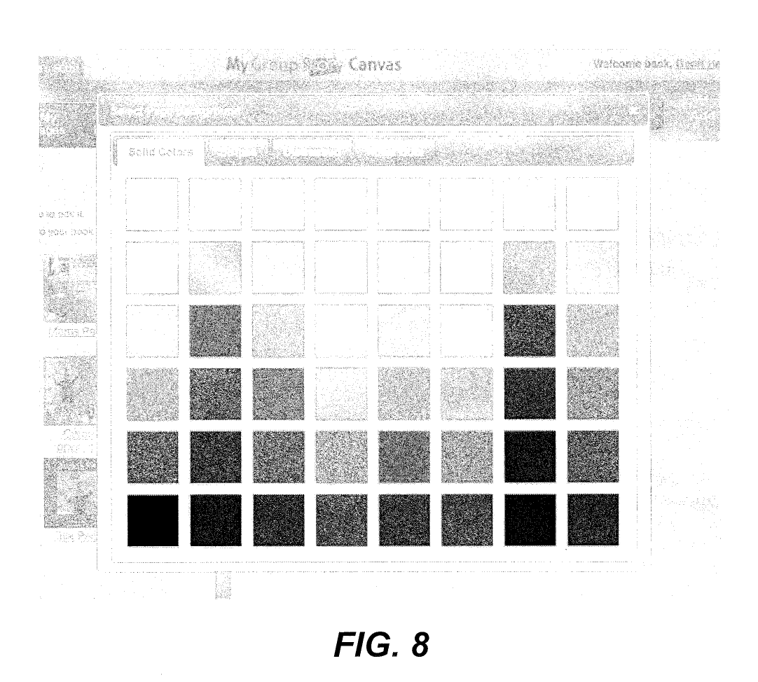

Users may also add backgrounds to their pages at block 385 and illustrated in FIG. 8. A user may choose the background from a color wheel (block 386), which may be a two-color blended gradient, or they may upload a chosen image at block 387. The user may apply the background to a single media page or to all the pages in the book that the user is assembling. The uploaded background images along with the graphics that are uploaded by a user may be made available to all users collaborating on the particular story at block 389 to be used in media pages that they are creating,

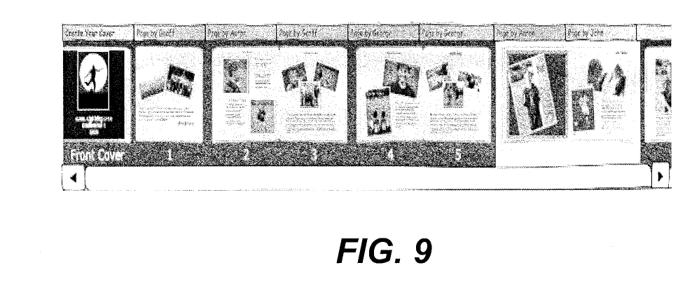

Once the user has completed work on a page at block 390 the page can be added to the user's book for this story as shown in FIG. 9. The media pages that a user creates may be made available to other users that are collaborators on a particular story and other users' media pages may be made available to the present user. Thus, at block 391, the user may add other users' pages to the media book being compiled. Similar to the manner in which a user selects media from a communal area to include in a media page, a user may also select pages created by him and others to be included in the user's media book for a particular story. Once a user has completed a media book for a particular story, the book may be published at block 392 and a hardcopy of the book may be ordered at block 393. Various printing options can be made available to the user, including soft cover and hard cover options of various sizes and paper quality. In addition, a digital copy may remain on the system for online access, The user may also email a copy or links to the media book to others at block 394.

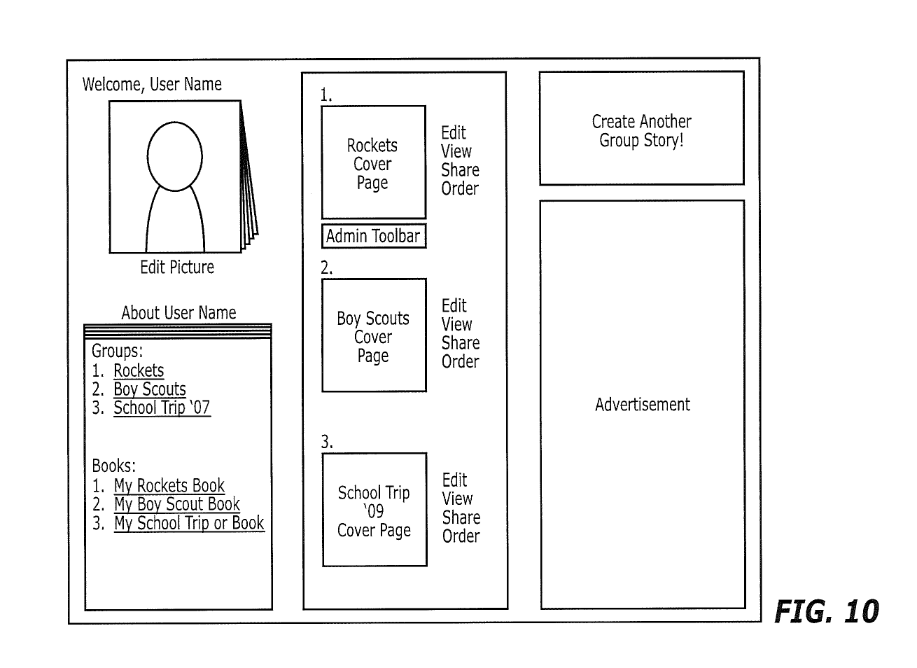

Operations may continue at block 315 where user returns to his profile page as shown in FIG. 10. The profile page may show the various books the user has created and/or is working on along with the various stories, groups, etc. of which the user is a participant. Various options can be provided for accessing the various media books active for the user including special options, such as quick links for inviting new friends, contributors, etc., if the user is the administrator for a particular story or group. If desired, the user may choose to edit a previously created story at block 395 and the operations described above may repeat. In some embodiments, an RSS feed or blog may be accessed at the user's profile page for each story or group that the user is involved in to allow a user to keep other users updated on the progress being made in creating media pages and assembling a media book and also to encourage other users to upload more media and/or finish their media pages.

The flowchart of FIG. 3 illustrates the architecture, functionality, and operations of some embodiments of systems, methods, and computer program products for creating shared media pages in accordance with some embodiments of the present invention. In this regard, each block represents a module, segment, or portion of code, which comprises one or more executable instructions for implementing the specified logical function(s). It should also be noted that in other implementations, the function(s) noted in the blocks may occur out of the order noted in FIG. 3. For example, two blocks shown in succession may, in fact, be executed substantially concurrently or the blocks may sometimes be executed in the reverse order, depending on the functionality involved.

Embodiments of the present invention may be described by way of example with respect to particular applications. Embodiments of the present invention may be implemented with a front end interface designed for a particular application. One particular application may be based on providing a place for fans of a particular sports team to collaborate and create media books based on their experiences with the team. For example, fans of a local football team, such as the Carolina Panthers, may wish to share their photos and stories about particular games, seasons, and the Panthers in general. Panthers' fan may not be located just in the Carolinas—there may be fans in San Diego, for example, who will take pictures and share their story of the Chargers-Panthers game. The fan will be able to pick and choose which photos and stories they want to use to create their own Panthers Ultimate Fan Book for a particular season.

These embodiments may also be used for fans of bands. As each band has fans around the world, they can recreate the bands tour by choosing photos and stories from those fans. Some fans may include set lists in his/her story—many diehard fans like to see that. A diehard fan's review of the concert may be something that someone would keep in their media book.

Another application may be to create media books targeted to help people who are suffering, feel isolated, or hopeless. Instead of people sharing a team experience, a personal, challenging experience may be shared. For example, a woman diagnosed with breast cancer may read through all the stories from women and families who have been affected by breast cancer. The woman can then select those stories that comfort her, or give her strength, hope, and solace. She can even design the book so that the page opposite a story she picked is simply a page with lines so that she can journal based on what that story means to her. Similarly, her husband, her children, and friends may find stories from their point of view and assemble them into their own media book. No longer will a person need to feel they are alone. We are part of a larger community and we can use their memories, their stories, and their experiences to help us.

These embodiments are not limited to a particular affliction. The community itself may help define the areas that may benefit from a collaborative media effort. People affected by things like addiction, suicide, childhood death, and diseases can benefit from the ability to create shared media stories with others who support them. It can help people realize and be comforted by the fact that regardless of the situation they are not alone. And that is an amazing gift to give someone.

Many variations and modifications can be made to the preferred embodiments without substantially departing from the principles of the present invention. All such variations and modifications are intended to be included herein within the scope of the present invention, as set forth in the following claims.

That which is claimed:

1. A method of creating shared media pages, comprising:
defining a story topic;
associating a plurality of users with the story topic;
receiving media items related to the story topic from at least one of the plurality of users; and
generating a plurality of pages, each of the plurality of users having at least one of the plurality of pages associated therewith, each of the plurality of pages comprising at least one of the media items selected by the associated one of the plurality of users.

2. The method of claim 1, further comprising:
generating a plurality of books associated with the plurality of users, respectively, each of the plurality of books comprising at least one of the plurality of pages selected by the associated one of the plurality of users.

3. The method of claim 1, wherein associating the plurality of users with the story topic comprises:
sending an invitation to the at least one of the plurality of users to collaborate in generating media related to the story topic; and
receiving an acceptance from the at least one of the plurality of users responsive to the invitation.

4. The method of claim 1, further comprising:
tagging at least one of the media items with a categorization indicium.

5. The method of claim 4, wherein the categorization indicium comprises a name of one of the plurality of users, an event, a location, and/or a date.

6. The method of claim 4, wherein generating the plurality of pages comprises:
sorting the media items based on a sort criterion;
wherein each of the plurality of pages comprises at least one of the sorted media items selected by the associated one of the plurality of users.

7. The method of claim 1, wherein generating the plurality of pages comprises:
annotating respective ones of the plurality of pages with text information received from respective ones of the plurality of users associated therewith.

8. The method of claim 1, wherein the media items comprise photographs, text, video, graphics, clip art, and/or audio.

9. A system for creating shared media pages, comprising:
a processor configured to define a story topic, associate a plurality of users with the story topic, receive media items related to the story topic from at least one of the plurality of users; and generate a plurality of pages, each of the plurality of users having at least one of the plurality of pages associated therewith, each of the plurality of pages comprising at least one of the media items selected by the associated one of the plurality of users.

10. The system of claim 9, wherein the processor is further configured to generate a plurality of books associated with the plurality of users, respectively, each of the plurality of books comprising at least one of the plurality of pages selected by the associated one of the plurality of users.

11. The system of claim 9, wherein the processor is further configured to send an invitation to the at least one of the plurality of users to collaborate in generating media related to the story topic and receive an acceptance from the at least one of the plurality of users responsive to the invitation.

12. The system of claim 9, wherein the processor is further configured to tag at least one of the media items with a categorization indicium.

13. The system of claim 12, wherein the categorization indicium comprises a name of one of the plurality of users, an event, a location, and/or a date.

14. The system of claim 12, wherein the processor is further configured to sort the media items based on a sort criterion, wherein each of the plurality of pages comprises at least one of the sorted media items selected by the associated one of the plurality of users.

15. The system of claim 9, wherein the processor is further configured to annotate respective ones of the plurality of pages with text information received from respective ones of the plurality of users associated therewith.

16. The system of claim 9, wherein the media items comprise photographs, text, video, graphics, clip art, and/or audio.

17. A computer program product for creating shared media pages, comprising:
a computer readable storage medium having computer readable program code embodied therein, the computer readable program code comprising:
computer readable program code configured to define a story topic;
computer readable program code configured to associate a plurality of users with the story topic;
computer readable program code configured to receive media items related to the story topic from at least one of the plurality of users; and
computer readable program code configured to generate a plurality of pages, each of the plurality of users having at least one of the plurality of pages associated therewith, each of the plurality of pages comprising at least one of the media items selected by the associated one of the plurality of users.

18. The computer program product of claim 17, further comprising:
computer readable program code configured to generate a plurality of books associated with the plurality of users, respectively, each of the plurality of books comprising at least one of the plurality of pages selected by the associated one of the plurality of users.

19. The computer program product of claim 17, wherein the computer readable program code configured to associate the plurality of users with the story topic comprises:
computer readable program code configured to send an invitation to the at least one of the plurality of users to collaborate in generating media related to the story topic; and
computer readable program code configured to receive an acceptance from the at least one of the plurality of users responsive to the invitation.

20. The computer program product of claim 17, further comprising:
computer readable program code configured to tag at least one of the media items with a categorization indicium.
